(19) United States
(12) Patent Application Publication
(10) Pub. No.: US 2009/0076916 A1
(43) Pub. Date: Mar. 19, 2009

(54) SYSTEMS AND METHODS FOR THIRD-PARTY AD SERVING OF INTERNET WIDGETS

(75) Inventors: Peter H.I. Kim, Pasadena, CA (US); Hyo Lee, Pasadena, CA (US)

Correspondence Address: BAKER & MCKENZIE LLP;PATENT DEPARTMENT, 2001 ROSS AVENUE, SUITE 2300, DALLAS, TX, 75201, US

(73) Assignee: INTERPOLS NETWORK INCORPORATED, Pasadena, CA (US)

(21) Appl. No.: 12/212,493

(22) Filed: Sep. 17, 2008

Related U.S. Application Data
(60) Provisional application No. 60/973,056, filed on Sep. 17, 2007.

(51) Int. Cl. G06Q 30/00

(52) U.S. Cl. 705/14

(57) ABSTRACT

A system for interactive delivery of rich media application pods, is disclosed. The system includes a web content server, a client web browser and an advertisement unit server. The web content server is configured to store a webpage having a designated location for an application pod ad unit. The application pod ad unit is configured to enable user interactions to request a rich media application pod. The client web browser is communicatively connected to the web content server and is configured to render the webpage and allow user interactions with the webpage. The advertisement unit server is communicatively connected to the client web browser and configured to receive the rich media application pod request, and dynamically process the rich media application pod to provide the requested rich media application pod.

### RELATED APPLICATIONS INFORMATION

This application claims priority under 35 U.S.C. 119(e) to U.S. Provisional Patent Application Ser. No. 60/973,056, entitled “Systems and Methods for 4th Party Ad Serving of Internet Widgets”, filed Sep. 17, 2007, which is incorporated herein in its entirety as if set forth in full. The entirety of the disclosure of the above-identified application is incorporated herein by reference as if set forth in full.

### BACKGROUND

1. Technical Field

The embodiments disclosed in this application generally relate to Internet advertising and more specifically to systems and methods for managing and delivering mini-applications, i.e. widgets, as a rich media ad format using Internet advertisement servers.

2. Background

With the proliferation of advertising on the Internet and the resulting marketing overload experienced by many Internet users, it is becoming increasingly important for Internet ad units to differentiate themselves from “rest of the crowd.” Rich-media ads are becoming the norm as they can deliver content that is animated, makes sounds, interacts with users, etc. Correspondingly, Internet marketing schemes have become more elaborate and sophisticated, sometimes integrating ad units into mini-applications (widgets) that can be downloaded on desktops or embedded into web pages (personal homepages/social networking pages) and shared virally. Widgets can provide users with content, features, or other applications that they find relevant and of use for them to include on their personal pages for daily access.

A significant amount of attention has been given to widget companies like SLIDE™ and ROCK YOU™ (the #1 and #2 widget companies, based on registered users). SLIDE™ has over 117 million users registered on their site. Their users upload their personal photos into the SLIDE™ widget so that they can post them on their MYSPACE™ or other social network/personal web page. Importantly, the SLIDE™ widget is non-branded and non-commercialized widget.

ROCK YOU™ provides an audio player widget to allow music files to be played on the social network/personal web pages—not unlike what the SLIDE™ widget does for photos. Both sites may have millions of users registered to use their widgets, but they do not effectively couple their widgets with ads and/or other revenue generating features/products. Users balk at ad banners on their widgets, so these companies offer branded widgets that the users can voluntarily grab and use on their own. The percentage of users that use them is unknown, as this is a relatively new offering. However, it is unlikely that a large number of users will swap out and change their existing widget for a branded widget on their own, and if so, only a very small percentage will.

The goal of these widget companies is to create a network of users to distribute ads or branded widgets. These companies are not ad-serving technology companies and their current widget products do not confine to publisher ad specifications and policies. Their challenge is to convert the registered users to actual users of ad products. Mainly, widget companies cannot accommodate the file size limitation imposed by the web-publisher (web content) sites, often being many times the maximum size limit. They also have difficulties in adhering to the strict privacy policies imposed by these sites.

Other companies like CLEARSPRING™, GIGYA™, or WIDGETBOX™ are more like clearing houses for widgets. They offer to build and host widgets—at a cost—and offer the ability to track/report usage and grabs of the widgets. That said, these platforms were designed to host and track widgets on sites, not widgets as ads on sites. Other widget companies like LABPIXIES™ and SPRINGWIDGETS™ offer the same services/products as CLEARSPRING™ and WIDGETBOX™, but for GOOGLE™ and FIM™ properties. These companies face the same challenges as all the other widget companies named above. Mainly, these companies are not ad-serving companies and therefore have a difficult time making money off if the distribution of widgets. Moreover, most web portals and web content publishers are reluctant to certify new companies to serve as ad-serving partners, as they do not want to go through the process to educate and fix integration problems for companies that do not specialize or have experience in ad-serving technologies and solutions. The above companies rely on other third-party ad-server companies to deliver their widget product as ad units, and are considered a fourth-party server. Therefore, there is a need for widget serving technologies that are able to leverage off of existing ad serving infrastructure and create, manage, host, ad-serve, track, and report widgets as certified ad formats, across all portals, web publishers, and ad networks.

### SUMMARY

Systems and methods for interactively delivering rich media application pods, are disclosed.

In one aspect, a system for interactive delivery of rich media application pods, is disclosed. The system includes a web content server, a client web browser and an advertisement unit server. The web content server is configured to store a webpage having a designated location for an application pod ad unit. The application pod ad unit is configured to enable user interactions to request a rich media application pod. The client web browser is communicatively connected to the web content server and is configured to render the webpage and allow user interactions with the webpage. The advertisement unit server is communicatively connected to the client web browser and configured to receive the rich media application pod request, and dynamically process the rich media application pod to provide the requested rich media application pod.

In another aspect, a computer implemented method for interactive delivery of rich media application, is disclosed. The method begins with a user interacting with an application pod request button on an application pod ad unit that the embedded in a webpage rendered on a web browser. Next, the user sends a request for a rich media application pod to the advertisement server. A menu panel associated with the requested rich media application pod is selected from a plurality of menu panels stored in the advertisement server. The selected menu panel is sent to the user's web browser. After viewing the menu panel, the user selects a website on which to embed the requested rich media application pod. The user then submits personal identification information to log on to the selected website. The selected rich media application pod is embedded to the selected website.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1A, is a block diagram illustrating a wide area network (WAN) for interactively delivering rich media application pods to users via an ad/application pod server, in accordance with one embodiment.

FIG. 1B, is a block diagram illustrating a WAN for interactively delivering rich media application pods to users via a 4^{th} party application pod server (i.e., 4^{th} party provider).

FIG. 2 is a flow chart illustrating an example process for interactive delivery of rich media application pods, in accordance with one embodiment.

FIG. 3 is a screenshot depicting a web browser window rendering a typical web content page with an embedded application pod ad unit, in accordance with one embodiment.

FIG. 4 is a screenshot depicting a menu panel that includes a description of the requested rich media application pod and one or more buttons that a user can click to select a destination website on which to embed the requested rich media application pod, in accordance with one embodiment.

FIG. 5 is a screenshot depicting an instruction panel that provides the user with instructions on how to embed the selected rich media application pod to the selected destination website.

FIG. 6 is a screenshot that depicts the login page of the selected destination website where the user can enter his/her personal identification information into one or more login fields in order to access his/her personal webpage(s), in accordance with one embodiment.

FIG. 7 is a screenshot that depicts the add media field of the user's personal webpage, in accordance with one embodiment.

FIG. 8 is a screenshot depicting the rich media application pod code segment being “copied and pasted” into the add media field of the user's personal webpage, in accordance with one embodiment.

FIG. 9 is a screenshot of the rich media application pod being rendered in the web browser after the code segment for the selected rich media application pod has been submitted by the user, in accordance with one embodiment.

### DETAILED DESCRIPTION

Embodiments herein are described and directed for systems and methods for interactive delivery of rich media application pods. It will be obvious, however, that the embodiments may be practiced without some or all of these specific details. In other instances, well known process operations have not been described in detail in order not to unnecessarily obscure the present invention.

As used herein, the Internet, the Web, or World Wide Web (WWW) uses a hypermedia (i.e., comprising of graphics, audio, video, plain text, hyperlinks, etc.) based system for enabling the browsing of Internet sites. As its name implies, the WWW (i.e., Internet) is comprised of many websites linked together allowing users to travel from one website to another simply by clicking on hyperlinks. To access the web, a user (i.e., client) typically runs a web browser program (e.g., FIREFOX™, NETSCAPE™, INTERNET EXPLORER™, SAFARI™, OPERA™, CAMINO™, etc.) that assists the user in navigating from among the various websites on the WWW and renders the web pages associated with those websites for viewing by the user.

Webpages are typically written in HyperText Markup Language (HTML), Dynamic HyperText Markup Language (DHTML) or Extensible HyperText Markup Language (XHTML). DHTML denotes a collection of technologies used together to create interactive and animated web sites by using a combination of a static markup language (i.e., HTML), a client-side scripting language (such as JAVASCRIPT™), a presentation definition language (i.e., CSS), and a Document Object Model. DHTML based webpages use client-side scripting to change the variables of the presentation definition language (i.e., HTML) to affect the look and function of otherwise “static” HTML page content, after the page has been fully loaded and during the rendering process.

Internet advertisements can take any form as along as it can be rendered onto a web browser or equivalent application. Examples include: static graphical banners, interactive polls, interactive games, multimedia clips, streaming video, etc. Rich-media denotes interactive multimedia web content that includes audio, graphics, image, video and animation in addition to traditional media (text and graphics).

As used herein, the term rich media application pods (i.e., widgets) denotes miniature applications (portable chunks of code) that can be installed and executed within any separate HTML-based web page by a user without requiring additional compilation. Generally, but not always, rich media application pods can be created using Extensible Markup Language (XML), RSS, DHTML, JAVASCRIPT™, or FLASH™. It should be understood, however, that the application pods can be created using essentially any programming language as long as they can be embedded and rendered within a HTML-based web page.

As discussed above, generally, many companies offer their widget solutions/services to advertisers as a way to host, track, and report their widgets, but each have their own way of distributing widgets on the major social networking sites (e.g., FACEBOOK™, MYSPACE™, BEBO™, PAGEFLAKE™, IGOOGLE™, etc). The key technology solution offered by all these companies is the “grab” function that allows users to post widgets on their personal and/or social network site pages. When users click on the “grab” button for most of the widgets currently in circulation, the widget sets off a FLASH™ or DHTML based overlay—that goes on top of the widget—having buttons to all the major sites where the widget code can be embedded. When users click on the desired site, a panel will appear with the widget code, login, and/or add button to include that widget on the desired site. A FLASH™ or DHTML based overlay that flips within the widget for the “grab” function has been termed a “carousel.”

A variety of issues arise when non ad-serving technology companies try to create widgets for marketing purposes. For example, most web portals (e.g., search engines, web content providers, etc.) will not allow 4^{th} party served widgets. That is, they will not allow a 3^{rd} party ad server to serve a web advertisement unit (embedded with a widget) to any web pages on their website when the embedded widget is hosted (and later served) by a 4^{th} party widget provider. Their concerns are: 1. the widgets that are provided by the 4^{th} party widget providers (with whom they have no direct commercial relationship with) will include malicious code that may adversely impact their users, 2. there is no guarantee that the 4^{th} party widget providers can handle the web traffic/load from a multitude of users downloading the hosted widget(s) at the same time, 3. there is no way for the web portal to protect their users or website from 4^{th} party widget providers who are malicious, 4. there is no way to ban 4^{th} party widget providers from offering widgets collect their user's personally identifiable information (this is to ensure the privacy and security of their user's personally identifiable information), and 5. that the size of the embedded widgets provided by the 4^{th} party widget providers will exceed their site specification limits for ad units (this may cause the ad unit embedded with the widget to not load properly on the web portal's web pages).

In view of the foregoing, it should therefore be fully appreciated that a variety of Internet ad server providers can benefit from the systems and methods described herein.

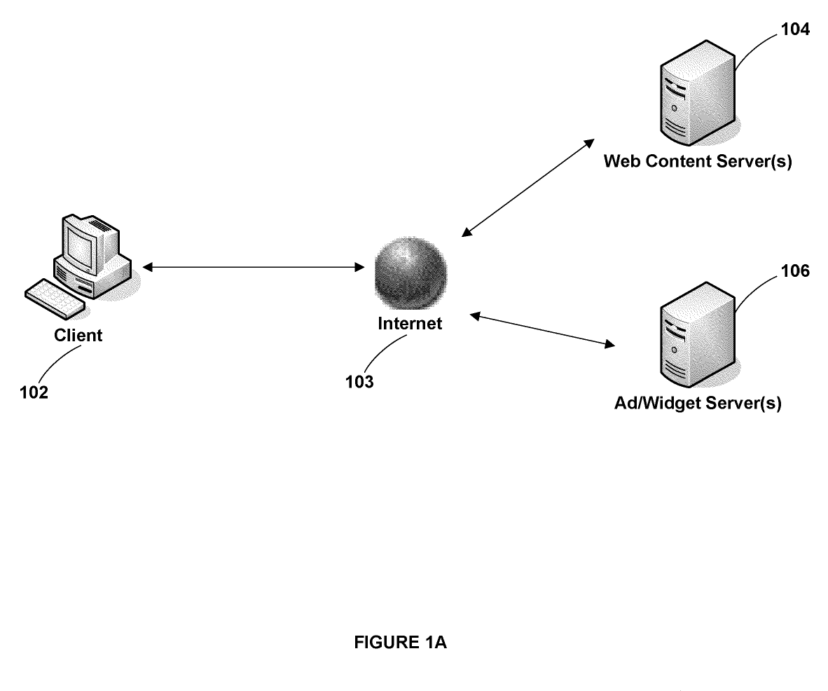

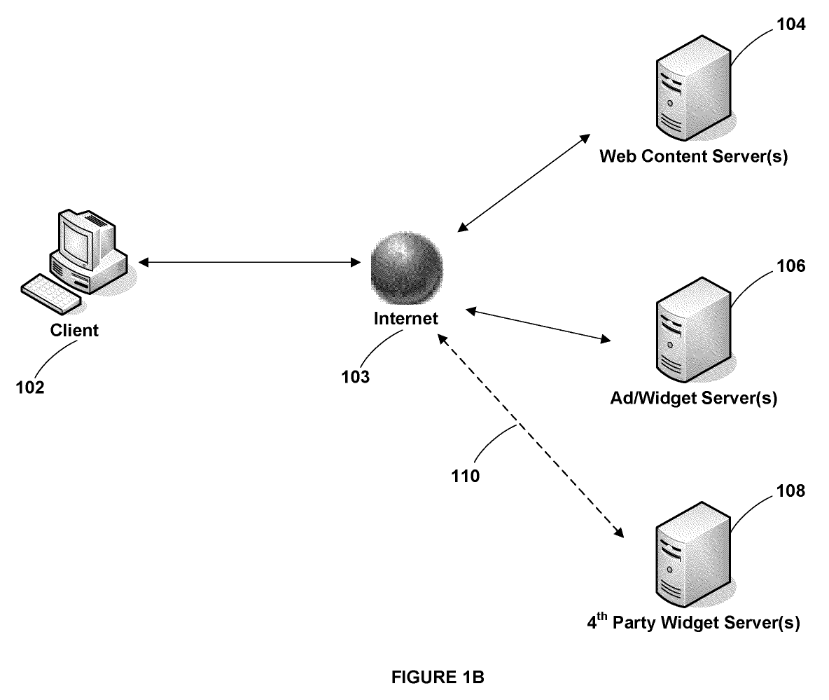

FIG. 1A, is a block diagram illustrating a wide area network (WAN) for interactively delivering rich media application pods to users, in accordance with one embodiment. As depicted, the system includes a client 102 (hosting a web browser) that is in communications by way of the Internet 103 with a web content server 104, and an ad/application pod server 106. It should be appreciated that the client 102 can be in communication with multiple servers of each server type (e.g., web content server 104, ad/application pod server 106, etc.) and that single servers were used in this depiction for the sake of simplicity and is not intended to limit the scenario to single servers of each server type.

For comparison purposes only, FIG. 1B depicts a 4^{th} party application pod server 108 being communicatively connected 106 (via a dotted line) to the Internet 103 and the client 102. This represents the system configuration discussed above with respect to 4^{th} party widget providers. Once the 4^{th} party ad server takes over, the 3^{rd} party ad server 106 loses control over the application pod interacting with the user 102. This creates more latency and is very hard for the 3^{rd} party ad server to control and meet all of the restrictions and requirements for the web-publisher ad requirements, specifications, and policies.

During an Internet 103 web surfing session, the client 102 makes a request for a web page from the web content server 104, which is configured to send the requested page back to the client 103 in the form of a Hypertext Markup Language (HTML) or equivalent file type (e.g., XML, Extensible Hypertext Markup Language (XHTML), and Extensible Bindings Language (XBL)). Embedded within the web page is a script that instructs the clients' 102 web browser to send a request for advertisement units to be sent from the ad/application pod server 106 to the client 102. Examples of programming languages that can be used to create the script include, JAVASCRIPT™, VBSCRIPT™, and ACTIONSCRIPT™. It should be understood, however, that the script can be created using any programming language as long as it can be processed by the client's 102 web browser to initiate a request for an advertisement panel from the ad/application pod server 106.

Continuing with FIG. 1A, once the script is delivered to the ad/application pod server 106, the Internet ad unit is generated and then returned to the web browser. There it is rendered onto or as part of the webpage by the web browser. Depending on the particular application, the ad/application pod server 106 can be configured to generate and serve rich media application pods (widgets) to the client 102 as well. That is, the ad unit can be embedded with a rich media application pod that is configured to allow user interactions (for example, via a user clicking on a “grab” button/function on the application pod or some combination of keyboard strokes) to generate a request for the rich media application pod and initiate an interactive process whereby the user can embed the requested rich media application pod to a personal and/or social network web page of his/her choice. In this way, the ad/application pod server 106 can be used to provide a rich media application pod that functions both as a rich media ad banner and a traditional rich media application pod.

In one embodiment, the interactive process involves the ad/application pod server 106 selecting a menu panel associated with the requested rich media application pod and sending the selected menu panel to the client 102. There a user can select a website (e.g., personal, social network, etc.) on which he/she desires to embed rich media application pod to from the one or more website selections provided on the menu panel. Next, the selected website can prompt the user for his/her personal identification information (e.g., username, password, etc.) to log on to the selected website. It should be noted that the user's personal identification information is submitted directly to the selected website as opposed to through a 3^{rd} party (i.e., ad/application pod server 106) or 4^{th} party (i.e., a 4^{th} party developer of the rich media application pod) host of the rich media application pod.

By allowing users to log on to the selected website (e.g., web publishers, social networking sites, etc.) directly, users never have to worry about a 3^{rd} or 4^{th} party company maliciously intercepting their personal identification information. Moreover, this practice avoids violating some of the privacy policies (such as a ban on the collection of personal identification information through ads on their site) set by web publishers/websites. After completing the logon process, the rich media application pod can be embedded into the selected website.

In one embodiment, the rich media application pod is automatically embedded into the selected website. That is, the code segment for the application pod is automatically inserted into the HTML code for the user's personal webpage hosted by the selected website. In another embodiment, an instruction panel associated with the selected website can be sent by ad/application pod server 106 to the client 102, whereby it provides the user with instructions on how to embed the selected rich media application pod to the selected website. That is, the instruction panel can provide the user with step-by-step instructions on how to embed the rich media application pod to the user's personal webpage hosted by selected website.

Once the application pod code segment is embedded into the user's personal webpage, it will cause the associated application pod to be served to the webpage by the ad/application pod server 106 whenever the webpage is rendered on a web browser. That is, the code segment will instigate the web browser to call for the associated application pod from the ad/application pod server 106.

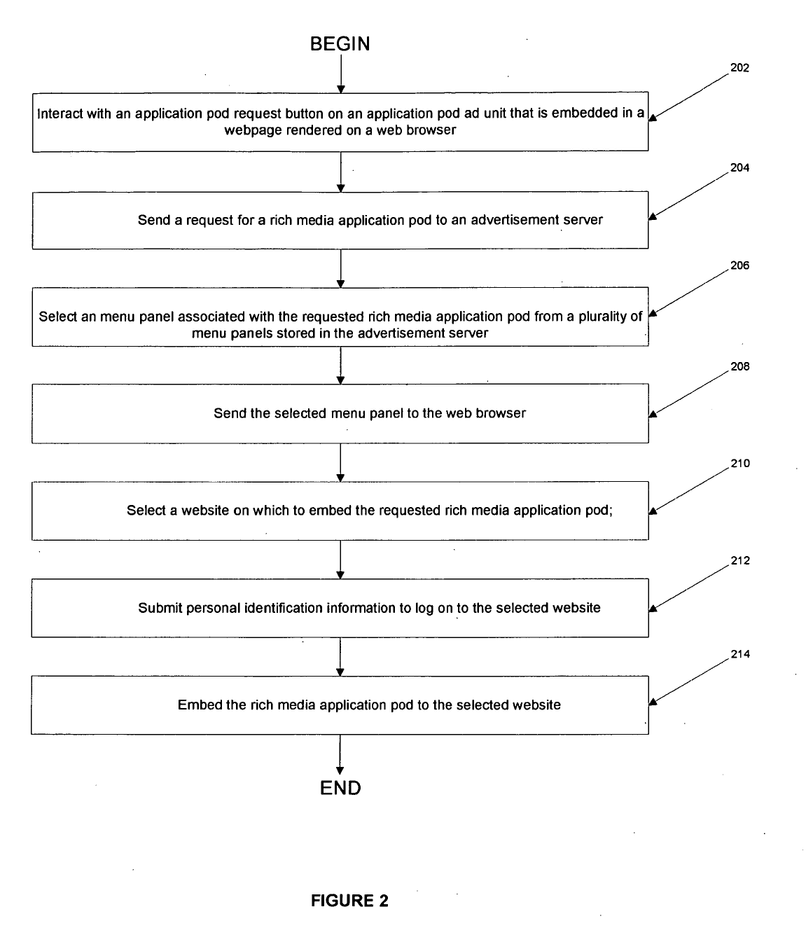

FIG. 2 is a flow chart illustrating an example process for interactive delivery of rich media application pods, in accordance with one embodiment. This process can be performed using the same or similar system elements to those described above. For example, web content pages can be stored in a web content server that is communicatively connected to a client (user) web browser through an Internet connection. Rich media application pods can be stored together with Internet ad units on a single ad/application pod server or multiple distributed ad/application pod server(s), which are also communicatively connected to the client web browser via an Internet connection. Embedded within the web content page can be a script that instructs the client's web browser to send a request for an Internet ad unit to the ad/application pod server. Once the client's web browser receives the requested Internet ad unit, it renders the ad unit for viewing. In one embodiment, the Internet ad unit can be utilized to interactively facilitate the distribution of application pods (widgets) containing ad content to a user's personal web page or social network web page. That is, the Internet ad units can be configured to enable a user to interactively embed application pods to a user-designated web page.

In step 202, a user interacts with the application pod request button on an application pod ad unit that is embedded on to a webpage that is rendered on a browser. In one embodiment, the interaction can be in the form of the user clicking on a “grab” button (or other equivalent command button) that is defined within the application pod ad unit. In another embodiment, the interaction can be in the form of the user clicking on any defined area within the application pod ad unit. It should be appreciated, however, that the interaction can be any user input (e.g., text input, mouse pointer input, etc.) as long as it can be recognized by the web browser as a command to trigger or execute a computing event. For example, a new browser window can be launched (computing event) by the user hitting a certain combination of keyboard strokes of clicking on a feature (e.g., “button,” defined area, etc.) that is within the metes and bounds of the application pod ad unit.

In step 204, in response to the user interaction with the application pod ad unit, the web browser sends a request for a rich media application pod to an advertisement server.

In step 206, the advertisement server selects a menu panel associated with the requested rich media application pod from a plurality of menu panels stored in the advertisement server. The menu panel can present the user with a description of the requested rich media application pod as well as the option to embed the rich media application pod to one or more destination (target) websites. Typically, these destination websites have partnering relationships (affiliations) with the owner(s) of the advertisement server. This ensures that the rich media application pods served by the advertisement server are compliant with the webpage specification requirements (e.g., size, functionality, etc.) of each destination website. Additionally, the menu panel can also include an option for the user to copy a line of code to manually embed the rich media application pod to any non-affiliated personal webpage of his/her choice.

In one embodiment, each one of the stored menu panels is associated with a single rich media application pod. That is, there is a one to one association between menu panels and rich media application pods. In another embodiment, each one of the stored menu panels can be associated with one or more rich media application pods.

In step 208, the advertisement server sends the selected menu panel to the web browser that initiated the request for the rich media application pod. In one embodiment, upon receipt of the selected menu panel, the web browser proceeds to open a new web browser window on which to render the selected menu panel. In another embodiment, the application pod ad unit is enveloped in a software wrapper that is configured to function as a flip panel unit. Therefore, upon receiving the selected menu panel, the software wrapper renders (i.e., flips) the selected menu panel over the application pod ad unit.

In step 210, the user selects a website on which to embed the requested rich media application pod. As discussed above, the menu panel can present the user with the option to embed the rich media application pod to one or more destination (target) websites. The destination websites can either be a social networking website or a personal non-affiliated website. Examples of social networking websites, include but are not limited to: FACEBOOK™, FRIENDSTER™, MYSPACE™, XANGA™, etc.

In one embodiment, when the user selects the destination website, the web browser opens an instruction panel that is associated with the selected destination website. The instruction panel provides the user with instructions on how to embed the selected rich media application pod to the selected destination website. In one embodiment, instruction panel is rendered on a new web browser window that is separate from the menu panel. In another embodiment, the menu panel is enveloped in a software wrapper that is configured to function as a flip panel unit. Therefore, upon opening the instruction panel, the software wrapper renders (i.e., flips) the instruction panel over the selected menu panel.

In step 212, the user proceeds with submitting his/her personal identification information (e.g., username, password, other authentication information, etc.) in order to log on to the selected website. Typically, this involves the user entering personal identification information directly to the login fields of the selected website in order to access his/her personal webpage(s) hosted by the website portal. As discussed above, by allowing users to log on to the selected website (e.g., web publishers, social networking sites, etc.) directly, users never have to worry about a 3^{rd} or 4^{th} party company maliciously intercepting their personal identification information. Moreover, this practice avoids violating some of the privacy policies (such as a ban on the collection of personal identification information through ads on their site) set by web publishers/web sites.

In step 214, the selected rich media application pod is embedded to the user's personal webpage on the selected website. That is, a line of code (code segment) for the rich media application pod is inserted into the HTML code for the user's personal webpage. In one embodiment, the line of code is automatically embedded to the user's personal webpage on the selected website. That is, menu panel includes a script that “copies and pastes” the line of code into the user's personal webpage. In another embodiment, the line of code is manually embedded to the user's personal webpage on the selected website. That is, the user has to manually “copy and paste” the line of code into his/her personal webpage. As discussed above, once the application pod code segment is embedded into the user's personal webpage, it will cause the associated application pod to be served to the webpage by the ad/application pod server whenever the webpage is rendered on a web browser. That is, the code segment will instigate the web browser to call for the associated application pod from the ad/application pod server.

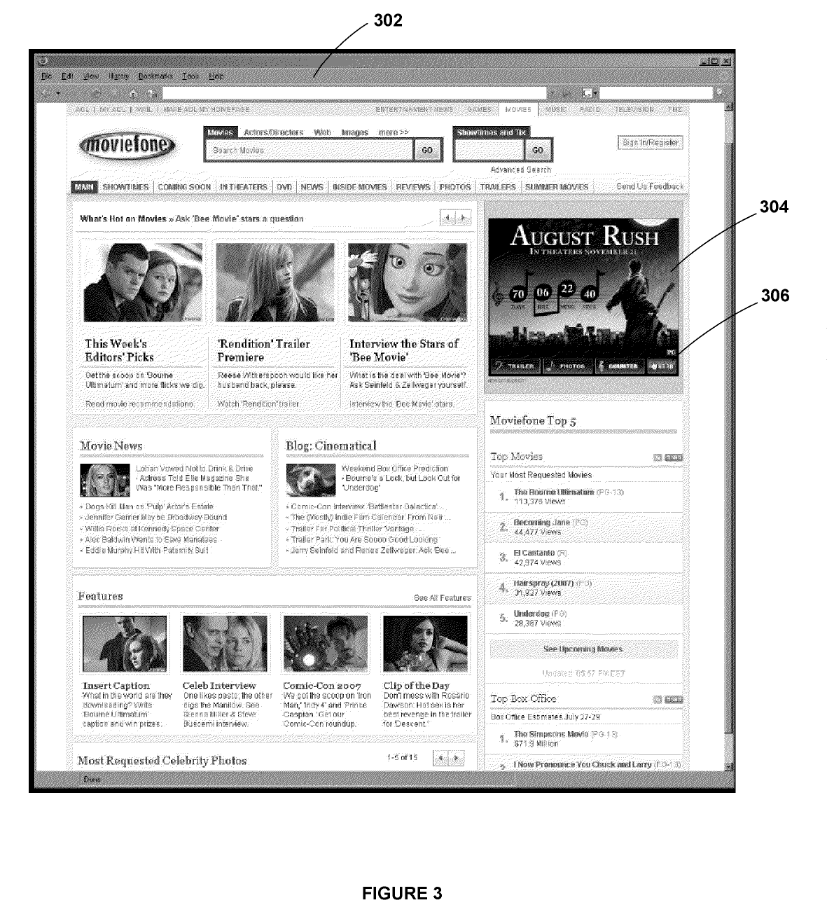

FIGS. 3 through 9 are screenshots that illustrate the various features of the systems and methods described in FIGS. 1 and 2. In FIG. 3, a screenshot is shown depicting a web browser window 302 rendering a typical web content page with an embedded application pod ad unit 304. The application pod ad unit 304 is rendered within a defined frame on the web content page. Typically, the application pod ad unit 304 specifications/dimensions are defined by the partnering relationships (affiliations) between the owner(s) of the advertisement server and the owner(s) of the web content portal providing the web content page. The application pod ad unit 304 can include a defined “grab” button 306 that a user can click to initiate a request for the rich media application pod associated with application pod ad unit 304.

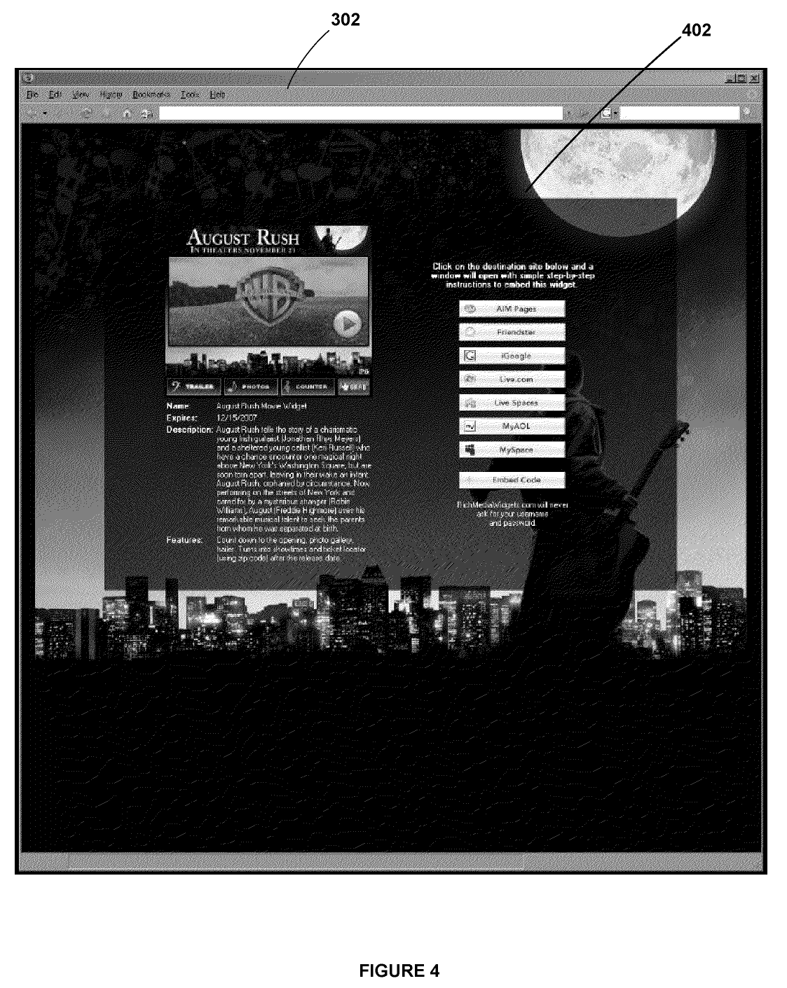

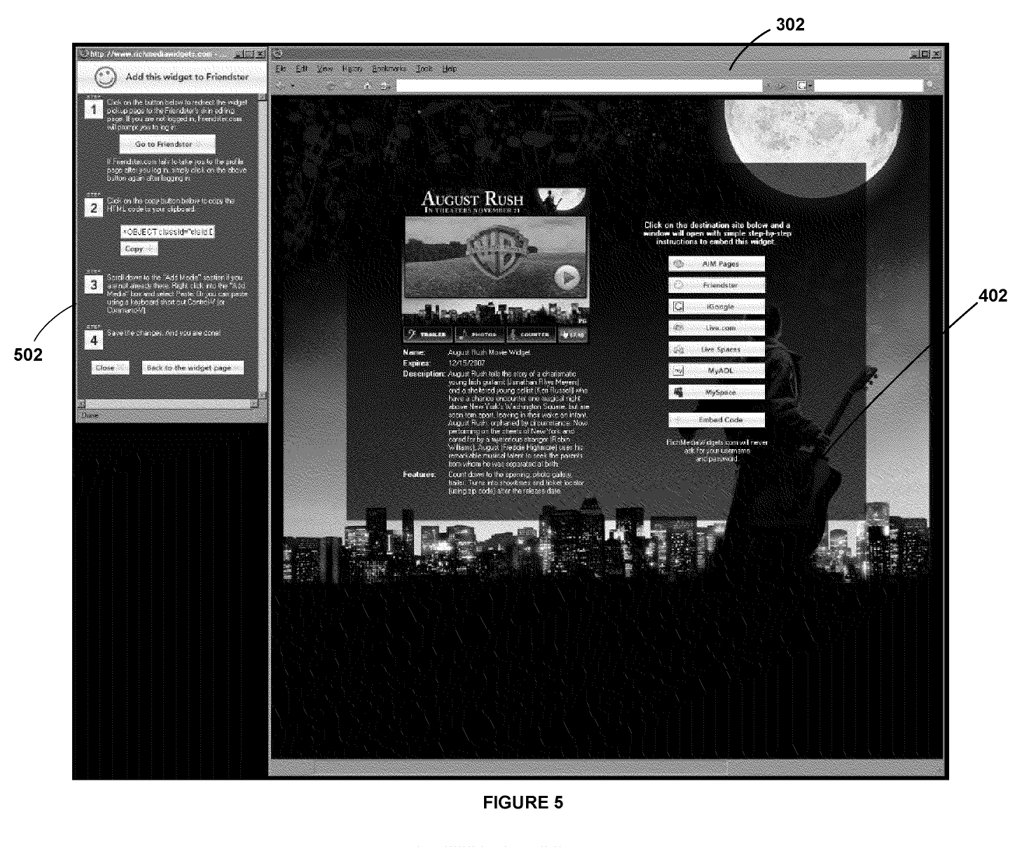

FIG. 4 is a screenshot that depicts a new web browser window 302 rendering a menu panel 402 that can include a description of the requested rich media application pod as well as one or more buttons that a user can click to select a destination website on which to embed the requested rich media application pod. Continuing to FIG. 5, in some embodiments, upon the user clicking on one of the buttons in the menu panel 402, a second new window can be opened to render an instruction panel 502. The instruction panel 502 can provide the user with instructions on how to embed the selected rich media application pod to the selected destination website.

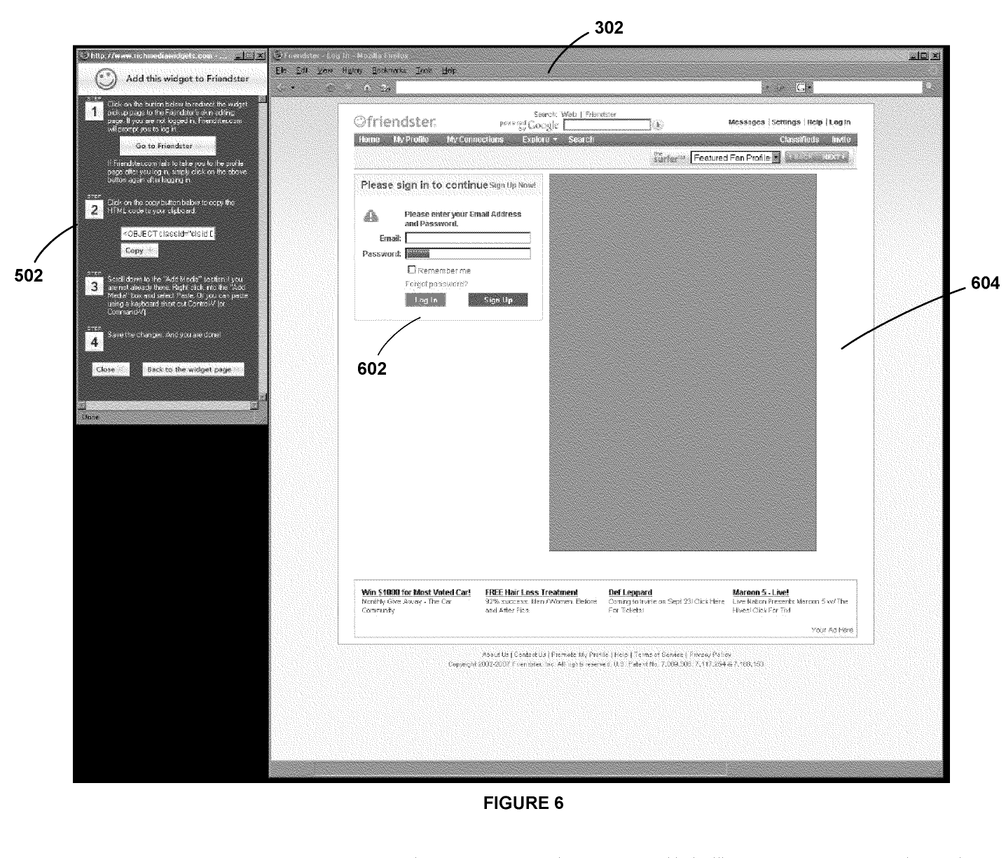

FIG. 6 is a screenshot that depicts the login page 604 of the selected destination website where the user can enter his/her personal identification information into one or more login fields 602 in order to access his/her personal webpage(s). Examples of the login fields 602 in the login page 604 include, but are not limited to: username, password, email address, etc. As discussed above, by allowing users to log on to the selected website (e.g., web publishers, social networking sites, etc.) directly, users never have to worry about a 3^{rd} or 4^{th} party company maliciously intercepting their personal identification information. Moreover, this practice avoids violating some of the privacy policies (such as a ban on the collection of personal identification information through ads on their site) set by web publishers/websites.

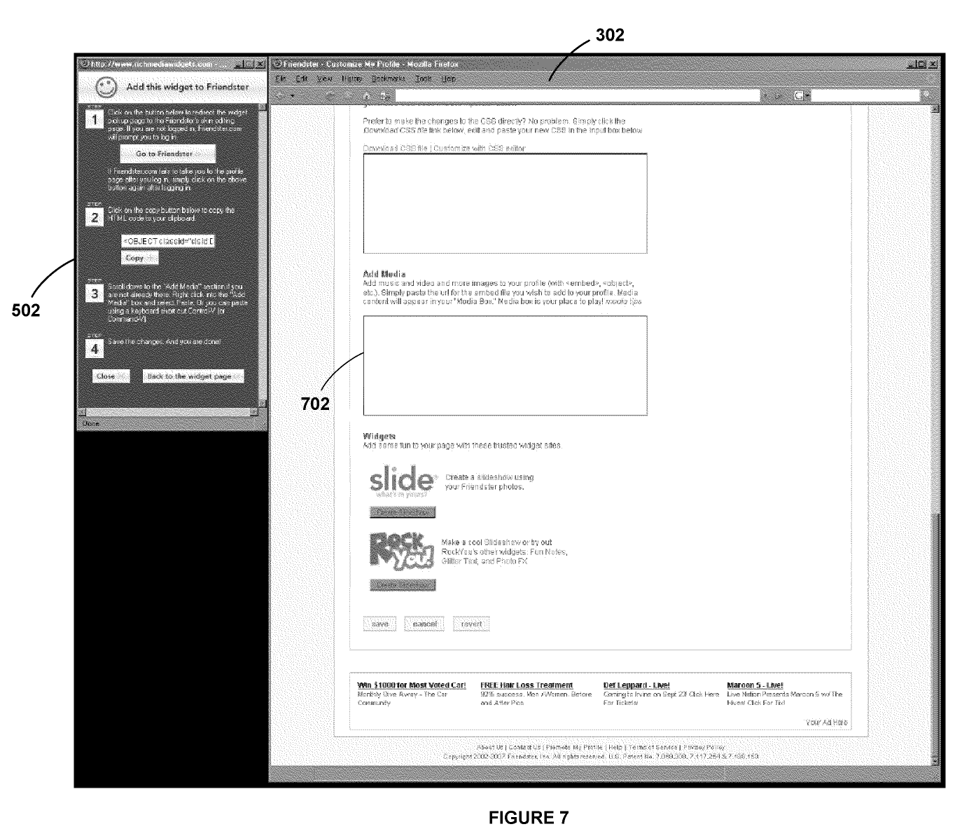

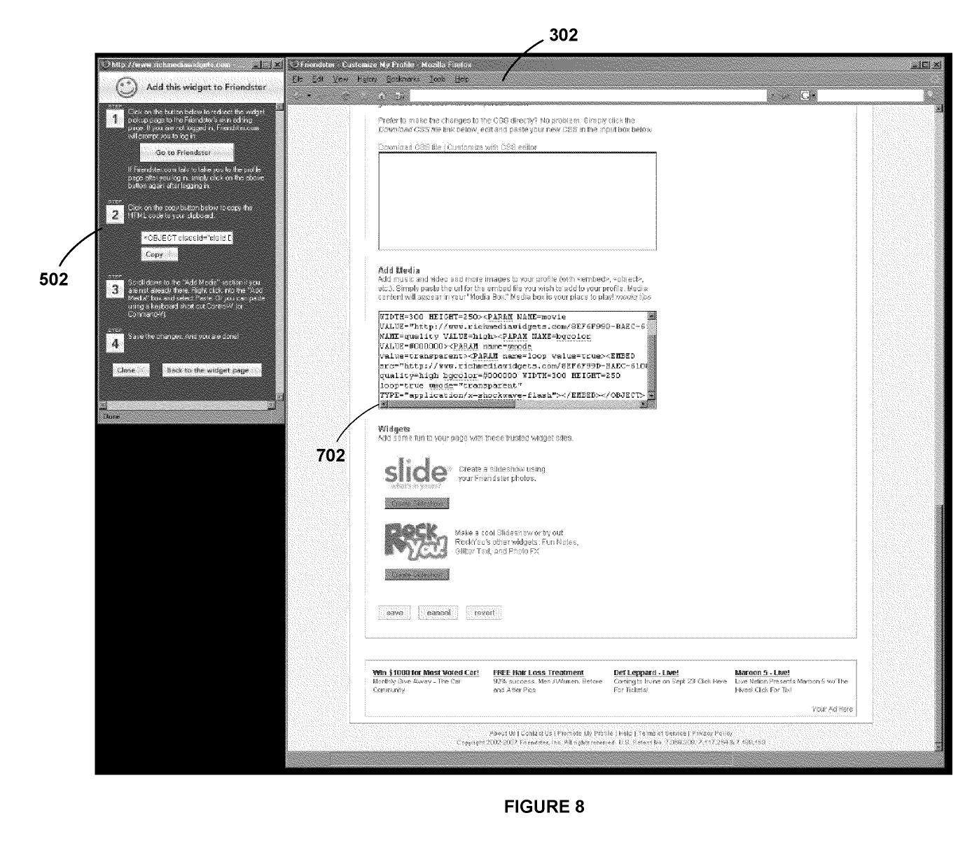

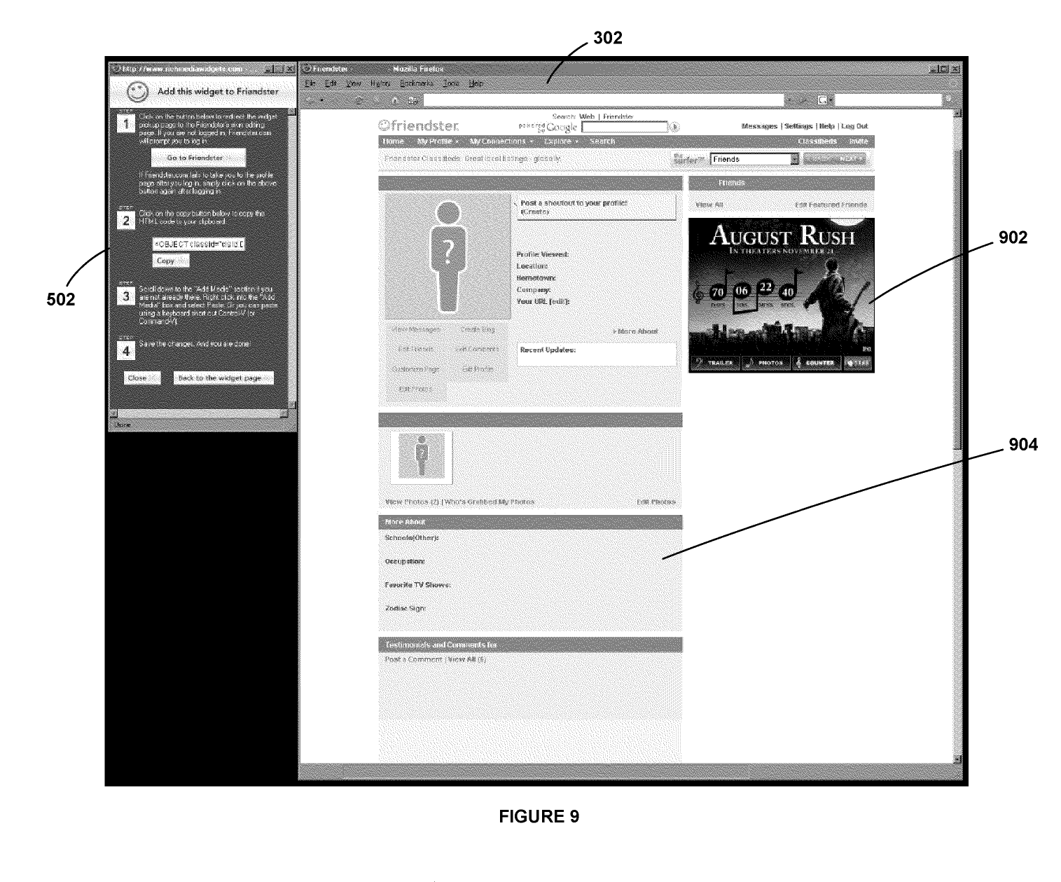

FIGS. 7 and 8 are screenshots that depict the rich media application pod code segment being embedded onto the user's personal webpage through the add media field 702 of the user's webpage. In one embodiment, the code segment is automatically embedded to the user's personal webpage on the selected website. That is, menu panel includes a script that “copies and pastes” the line of code directly into the add media field 702 of the user's personal webpage and submits it. In another embodiment, the code segment is manually embedded to the user's personal webpage on the selected website. That is, the user has to manually “copy and paste” the code segment into the add media field 702 of the user's personal webpage. FIG. 9 is a screenshot of the rich media application pod 902 being rendered in the web browser 302, after the code segment for the selected rich media application pod has been submitted by the user. That is, the application pod code segment is embedded into the user's personal webpage, it will cause the associated application pod to be served to the webpage by the ad/application pod server whenever the webpage is rendered on a web browser. That is, the code segment will instigate the web browser to call for the associated application pod from the ad/application pod server.

Any of the operations that form part of the embodiments described herein are useful machine operations. The invention also relates to a device or an apparatus for performing these operations. The systems and methods described herein can be specially constructed for the required purposes, such as the specialty servers (e.g., ad server, web content servers, etc.) discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A system for interactive delivery of rich media application pods, comprising:
a web content server configured to store a web page having a designated location for an application pod ad unit, wherein the application pod ad unit is configured to enable user interactions to request a rich media application pod;
a client web browser communicatively connected to the web content server, the client web browser configured to render the web page and allow user interactions with the web page; and
an advertisement unit server communicatively connected to the client web browser, the advertisement server configured to,
receive the rich media application pod request; and
dynamically process the rich media application pod request and interactively provide the requested rich media application pod to a website designated by the user.

2. The system for interactive delivery of rich media application pods, as recited in claim 1, wherein the interactive process of providing the requested rich media application pod, further includes:
the advertisement unit server,
selecting a menu panel associated with the requested rich media application pod from a plurality of menu panels stored in the advertisement server, and
sending the selected menu panel to the client web browser; and
a user,
selecting a website on which to embed the requested rich media application pod from the menu panel,
submitting personal identification information to log on to the selected website, and
embedding the rich media application pod to the selected website.

3. The system for interactive delivery of rich media application pods, as recited in claim 2, further including:
opening an instruction panel that is associated with the selected website, wherein the instruction panel provides instructions on how to embed the rich media application pod to the selected website.

4. The system for interactive delivery of rich media application pods, as recited in claim 2, wherein the rich media application pod is embedded on to a webpage hosted by the selected website.

5. The system for interactive delivery of rich media application pods, as recited in claim 4, wherein the rich media application pod is automatically embedded into the webpage.

6. The system for interactive delivery of rich media application pods, as recited in claim 4, wherein the rich media application pod is manually embedded into the webpage by a user.

7. The system for interactive delivery of rich media application pods, as recited in claim 2, wherein the menu panel is opened as a new webpage within the web browser.

8. The system for interactive delivery of rich media application pods, as recited in claim 3, wherein the instruction panel is opened as a new webpage within the web browser.

9. The system for interactive delivery of rich media application pods, as recited in claim 1, wherein the selected website is a personal website.

10. The system for interactive delivery of rich media application pods, as recited in claim 1, wherein the selected website is a social networking website.

11. A computer implemented method for interactive delivery of rich media application pods, comprising:
interacting with an application pod request button on an application pod ad unit that is embedded in a webpage rendered on a web browser;
sending a request for a rich media application pod to an advertisement server;
selecting a menu panel associated with the requested rich media application pod from a plurality of menu panels stored in the advertisement server;
sending the selected menu panel to the web browser;
selecting a website on which to embed the requested rich media application pod from the menu panel;
submitting personal identification information to log on to the selected website; and
embedding the rich media application pod to the selected website.

12. The computer implemented method for interactive delivery of rich media application pods, as recited in claim 11, further including:
the advertisement server,
sending an instruction panel that is associated with the selected website to the web browser, wherein the instruction panel provides instructions on how to embed the rich media application pod to the selected website.

13. The computer implemented method for interactive delivery of rich media application pods, as recited in claim 11, wherein the rich media application pod is embedded on to a webpage hosted by the selected website.

14. The computer implemented method for interactive delivery of rich media application pods, as recited in claim 13, wherein the rich media application pod is automatically embedded into the webpage.

15. The computer implemented method for interactive delivery of rich media application pods, as recited in claim 13, wherein the rich media application pod is manually embedded into the webpage by a user.

16. The computer implemented computer implemented method for interactive delivery of rich media application pods, as recited in claim 11, wherein the menu panel is opened as a new webpage within the web browser.

17. The computer implemented method for interactive delivery of rich media application pods, as recited in claim 12, wherein the instruction panel is opened as a new webpage within the web browser.

18. The computer implemented method for interactive delivery of rich media application pods, as recited in claim 11, wherein the selected website is a personal website.

19. The computer implemented method for interactive delivery of rich media application pods, as recited in claim 11, wherein the selected website is a social networking website.
